(19) United States
(12) Patent Application Publication
(10) Pub. No.: US 2014/0224357 A1
(43) Pub. Date: Aug. 14, 2014

(54) Soil Classifier

(71) Applicant: Shawn Patrick Greenwood, Telluride, CO (US)

(72) Inventor: Shawn Patrick Greenwood, Telluride, CO (US)

(21) Appl. No.: 14/174,912

(22) Filed: Feb. 7, 2014

Related U.S. Application Data
(60) Provisional application No. 61/763,809, filed on Feb. 12, 2013.

(51) Int. Cl. B02C 23/08

(52) U.S. Cl. CPC B02C 23/08
USPC 137/544

(57) ABSTRACT

A lightweight soil classifier consisting of a singular motor, a fully articulated flexible Vierendeel frame motor mount platform and conical basket lid weldment for the self-aligning and centering of a rotating shaft through a cylindrical screened classifier basket containing classified media, with an impervious conical bottom and a cylindrical bearing post incorporating a conduit, a classifier drive shaft with a semi-rigid coupling to the motor and a pumping screw extending through the bearing post conduit and submerged bearing surfaces to develop fluid dynamic bearing films of fine soils and liquid vehicle, fitted with an inverted cup-shaped classifier head consisting of outwardly projecting spirally arrayed classifier pins located within the confines of the classifier basket. Along with a rotating blade fastened to the tip of the classifier shaft below the basket bottom, the soil classifier is self-supported on feet within and on the floor of a vessel enabling a process for the deconglomeration, dispersion, particle size reduction and classification of soils all to within a common size.

### BACKGROUND OF THE INVENTION

1. Field of the Invention

This invention relates to a self-supporting soil classifier, economically constructed, light weight and able to be lifted by hand into or out of a vessel, and more particularly relates to an improved form of similarly purposed machines by simplifying and reducing the number of mechanical components and weight by applying a combination of fluid dynamic bearing films supported by submerged bearing surfaces, a self-centering pumping screw housed in a conduit and a fully articulated motor platform.

2. Background

Similarly purposed machines such as basket and/or grinding mills are used for the deconglomeration and particle size reduction of solids within a liquid vehicle facilitating the use of a grinding media agitated by the use of high speed rotating blades, shafts, bearings, bearing housings, pulleys, belts, motors and rigid structural supports. These machines are generally supported outside of a vessel or affixed to the top edge of a vessel. Complex drive mechanisms are often supported by heavy bearing housing assemblies and without the advantages of fairly robust motor frames. High speed rotating shafts are designed either with or without a shaft end support. Without an end support, the shaft diameter and bearings must be large enough to prevent a catastrophic bending failure. An advantage of an end support is the ability to use smaller diameter shafts and bearings. The end support is typically a bushing or sealed bearing submerged in the process. The disadvantage of a submerged bushing or sealed bearing is the continuous maintenance concerns of wearing parts and the potential of process contamination due to wear surface material attrition.

Similar machines without the use of submerged bearings such as Araki's U.S. Pat. Nos. 5,447,372 and 7,275,704; Inoue's U.S. Pat. Nos. 6,029,915 and 6,325,310; and Ishikawa's U.S. Pat. No. 5,346,147 include the use of drive mechanisms that are well engineered to withstand excessive shaft deflections and are suitable for a wide variety of processes with minimal concern of solid accumulations in or around mechanical components that could be detrimental to the finished product.

A bushing or bearing near the end of a high speed rotating shaft is effective in reducing critical shaft deflections and as a result reduction of shaft diameters, bearing sizes and related drive components. Submerged bushings and/or bearings are found in several other similarly purposed machines such as Getzmann's U.S. Pat. No. 6,565,024; Hockmeyer's U.S. Pat. Nos. 5,184,783 through 7,883,036; Schieweg's U.S. Pat. No. 7,641,137; and D'Errico's U.S. Pat. No. 8,047,459. These machines are also referenced to illustrate the similar use of basket milling technology with emphasis on the downward direction of the process flow through the screened bottom of a cylindrical basket.

Some of the referenced patents include pumping screws and/or propellers either affixed to or part of a shaft for pumping process fluid downward through their respective assemblies. Where a bushing is used to stabilize a shaft, grinding media often escapes the basket which can be detrimental to the process and related mechanical components.

Although combinations of pumping screws and/or propellers plus the use of submerged bearings or bushings are used throughout the wet grinding basket milling industry as indicated above, intentionally pumping process components and liquid through main bearings for further deconglomeration and particle size reduction of solids within a liquid vehicle is not evident in similarly purposed machines.

The present invention includes the intentional pumping and particle size reduction of process components and liquid vehicle through submerged bearing surfaces forming fluid dynamic bearing films as the main radial and axial bearing supports of a classifier shaft assembly fitted to a fully articulated motor mounting platform providing multiple degrees of freedom. As a result, the drive system can be reduced in complexity, weight and cost.

All patents, patent applications, provisional patent applications and publications referred to or cited herein, are incorporated by reference in their entirety to the extent they are not inconsistent with the explicit teachings of the specification.

| | | | |
|---|---|---|---|
| 8,047,459 | November 2011 | D'Errico | 241/21 |
| 7,641,137 | January 2010 | Schieweg | 241/172 |
| 7,559,493 | April 2009 | Hockmeyer et al. | 241/21 |
| 7,275,704 | October 2007 | Araki | 241/172 |
| 7,175,118 | February 2007 | Hockmeyer | 241/172 |
| 6,565,024 | May 2003 | Getzmann et al. | 241/171 |
| 6,325,310 | December 2001 | Inoue | 241/46.01 |
| 6,029,915 | February 2000 | Inoue | 241/17 |
| 5,820,040 | October 1998 | Hockmeyer et al. | 241/46.17 |
| 5,497,948 | March 1996 | Hockmeyer | 241/46.17 |
| 5,447,372 | September 1995 | Araki et al. | 366/299 |
| 5,346,147 | September 1994 | Ishikawa et al. | 241/172 |
| 5,360,273 | November 1994 | Buckmann | 384/99 |
| 5,184,783 | February 1993 | Hockmeyer et al. | 241/172 |
| 4,813,617 | March 1989 | Knox, Jr. et al. | 241/46.06 |
| 4,637,555 | January 1987 | Furuichi et al. | 241/46.02 |
| 4,570,863 | February 1986 | Knox, Jr. et al. | 241/33 |
| 4,302,147 | November 1981 | Cherubim | 415/92 |
| 4,096,057 | June 1978 | Porritt et al. | 208/11 LE |
| 2,590,761 | March 1952 | R. F. Edgar | |
| 1,951,684 | March 1934 | Wells, H. D. | |
| 1,113,716 | October 1914 | Nikola Tesla | |

### SUMMARY OF THE INVENTION

The present invention reduces the complexity of similarly purposed machines. This invention includes the intentional pumping and particle size reduction of process components and liquid vehicle through a gap between opposing bearing surfaces which develops a fluid dynamic bearing film as the radial bearing support of a classifier shaft assembly with an integral self-aligning pumping screw housed within a bearing post conduit secured to the bottom center of a reversible cylindrical wire formed basket assembly containing classified media. Flow of process components continues through the conduit and passes through an interstitial space formed between a thrust bearing and a bearing surface which develops a second fluid dynamic bearing film to support axial shaft loads. A constant-forced compression clamping mechanism is used to secure a bushing or bearing of sorts to the drive shaft which eliminates destructive tensile stresses within the bearing material during high speed rotations. The drive shaft assembly includes an integral hub with profiled spokes and a thin-walled rotating cylindrical body with an array of outwardly positioned pins used to agitate classified media. The profiled spokes recirculate classified media around the wall of the cylindrical body which provides for a more even and efficient distribution of classified media on the vertical walls of the basket. The classifier drive shaft is semi-rigidly coupled to a motor that is mounted to a fully articulated platform with multiple degrees of freedom which further reduces the complexity, weight and the inherent cost of construction with the ensuing benefit of producing a portable machine which is self-supporting within a vessel that is used to classify soils to all the same size.

It is understood that the foregoing examples are merely illustrative of the present invention. Certain modifications of the articles and/or methods employed may be made and still achieve the objectives of the invention. Such modifications are contemplated as within the scope of the claimed invention.

### BRIEF DESCRIPTION OF THE DRAWINGS

FIG. 1 is a cross section view of a soil classifier for continuous classification of particulate material which is constructed in accordance with an embodiment of this invention;

FIG. 2 is an exploded isometric view of the motor mount weldment;

FIG. 3 is an exploded isometric view of the classifier basket assembly;

FIG. 4 is an exploded view of the classifier shaft assembly;

FIG. 5 is an isometric view of a classifier head weldment which is constructed in accordance with an embodiment of this invention;

FIG. 6 is a side view of the classifier head weldment;

FIG. 7 is a view of the spacing of classifier pins as situated around the perimeter of a classifier head weldment which is constructed in accordance with an embodiment of this invention;

FIG. 8 is a top view of the classifier head weldment taken on the line 8-8 in FIG. 6;

FIG. 9 is a section view taken on line 9-9 in FIG. 6;

FIG. 10 is a partial cross section view of this invention charged with classified media, soils to be classified and a liquid vehicle;

FIG. 11 is a cross section view of this invention in the process of classifying soils;

FIG. 12 is a partial section view taken on line 12-12 of FIG. 11;

FIG. 13 is an illustration of the pumping screw with an exaggerated cross section of the conduit within the bearing post;

FIG. 14 is a cross-section illustrating a fluid dynamic bearing film taken from view 14 of FIG. 13;

FIG. 15 illustrates the multiple degrees of freedom, an embodiment of this invention.

### A DETAILED DESCRIPTION OF THE INVENTION

In the following detailed description and the drawings, like reference characters indicate like parts.

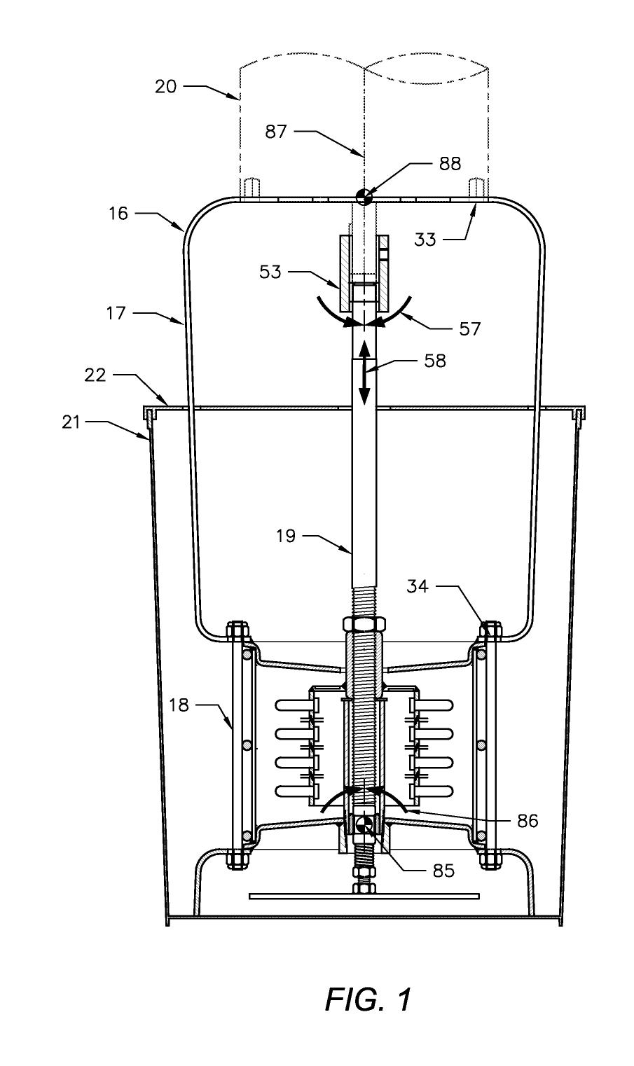

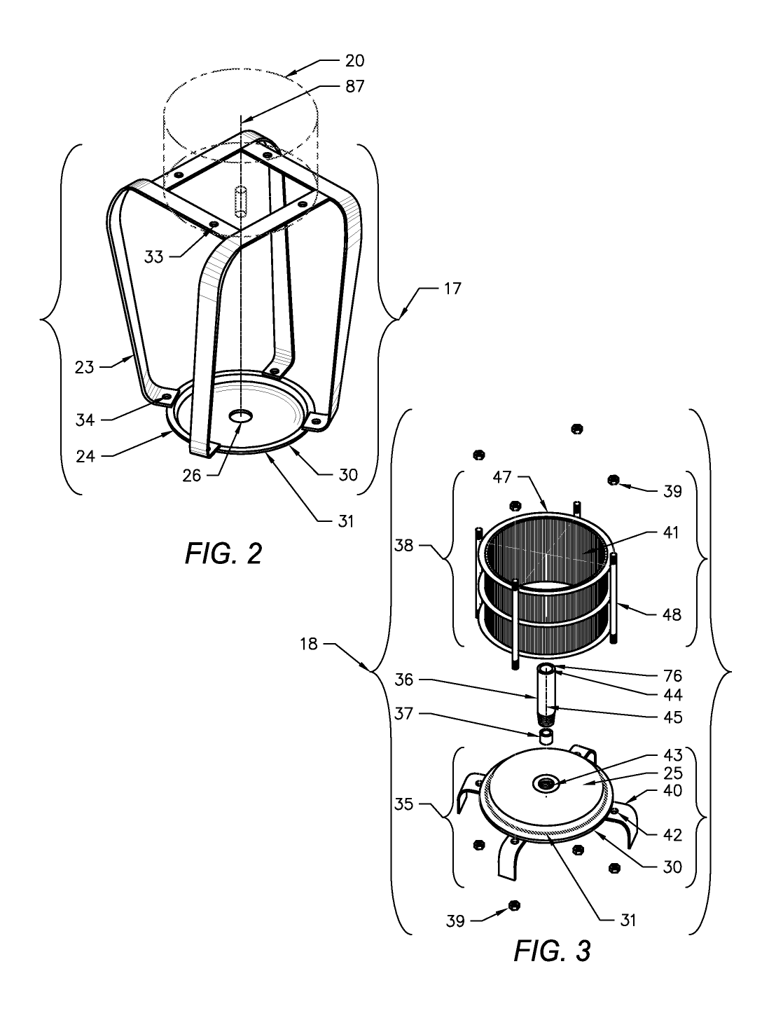

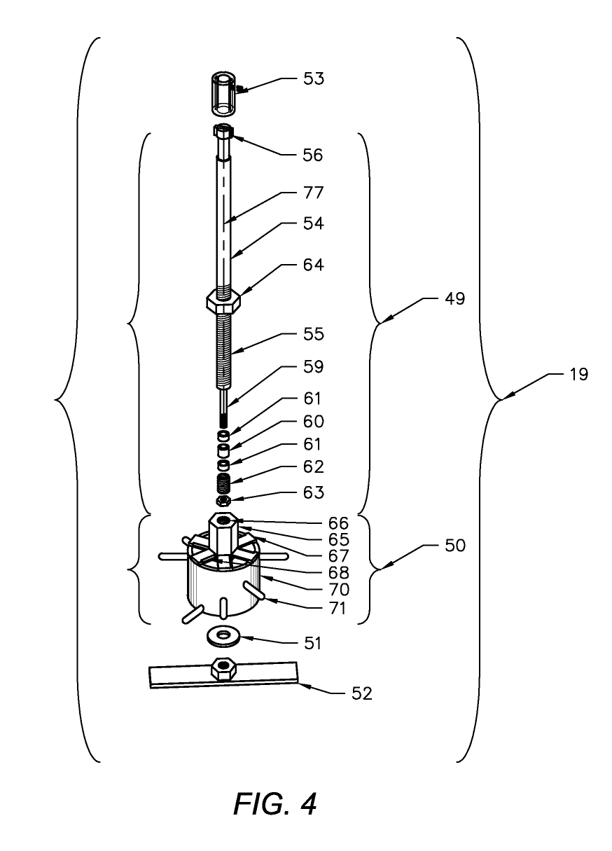

FIG. 1 illustrates a soil classifier 16 constructed in accordance with an embodiment of this invention. The soil classifier 16 includes a motor mount weldment 17 (FIG. 2); a classifier basket assembly 18 (FIG. 3); a classifier shaft assembly 19 (FIG. 4); a motor 20; all of which is self-supporting within and on the floor of vessel 21 and covered with a lid 22. The vessel 21 (FIG. 1) with the lid 22 in this invention is a covered pail which may also serve as a storage container for the soil classifier 16.

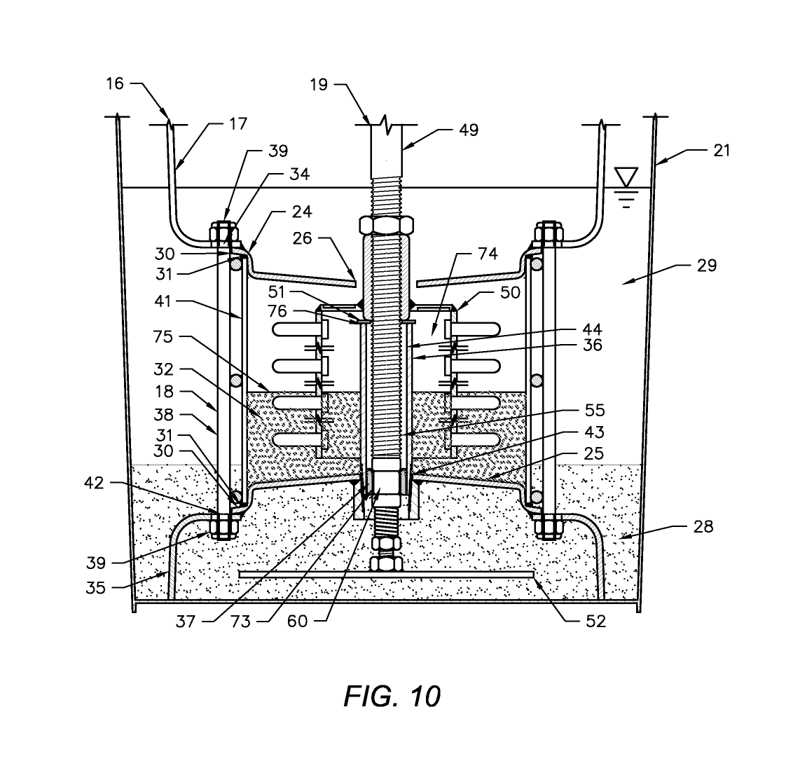

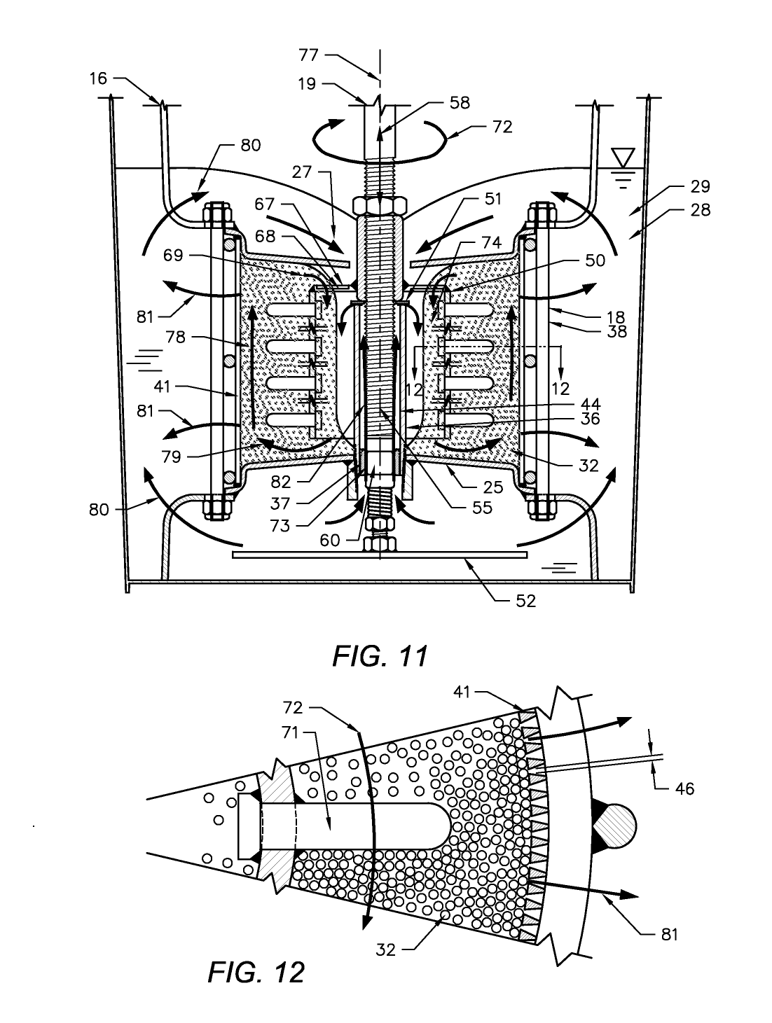

FIG. 2 illustrates the motor mount weldment 17 consisting of multiple bars 23 bent to a shape to match the mounting surface of a motor 20 and extended to the basket lid 24 collectively forming a singular fully articulated Vierendeel frame. The basket lid 24 is formed to a shape matching that of the basket bottom 25 (FIG. 3), inverted to provide a funnel shaped entrance to the basket inlet 26, sized accordingly for the flow through the basket inlet 27 of soils 28 and liquid vehicle 29 (see FIG. 11), and a recessed lip 30 to protect and preserve a basket gasket 31 from the abrasive action of grinding or classified media 32 (FIGS. 10, 11, and 12). The bars 23 include motor fastener holes 33 and classifier basket assembly fastener holes 34 for securing the motor 20 and the classifier basket assembly 18 respectively (FIG. 1). The basket gasket 31 functions as a seal to contain classified media 32 within the classifier basket assembly 18 (see FIG. 10).

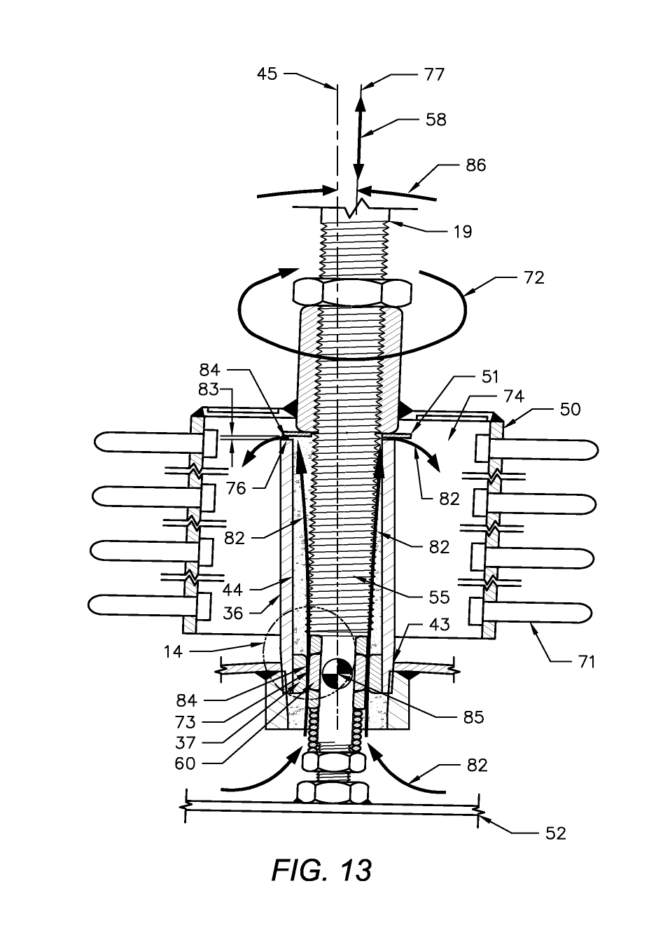

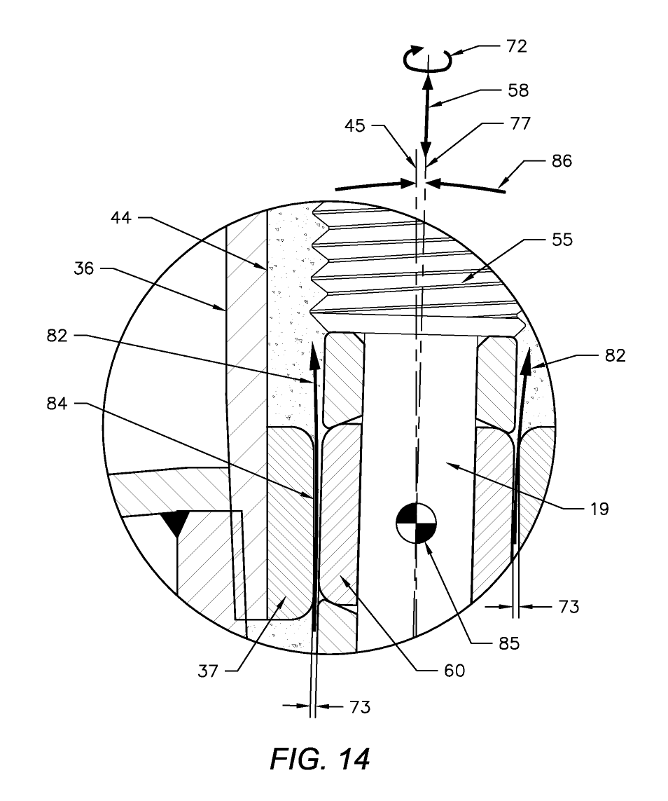

FIG. 3 illustrates the classifier basket assembly 18 consisting of a basket bottom weldment 35; a bearing post 36 and a fixed radial bearing 37; a classifier screen weldment 38 and basket fasteners 39. The basket bottom weldment 35 consists of an impervious basket bottom 25 with the same profile as the basket lid 24 (FIG. 2). Multiple bars bent to form basket feet 40 are welded to the basket bottom 25 to form the basket bottom weldment 35. The basket bottom 25 is sloped (see FIGS. 10 and 11) towards its perimeter coinciding with the inside of the longitudinal screen wires 41. Basket feet fastener holes 42 are used to secure the classifier screen weldment 38 with basket fasteners 39 while encapsulating the basket gasket 31 within the recessed lip 30. The fixed radial bearing 37 is positioned inside the bearing post 36. The bearing post 36 is secured to the threaded center of the basket bottom 43. The bearing post 36 maintains a conduit 44 (see exaggerated view in FIG. 13) and the conduit centerline 45. The classifier screen weldment 38 consists of trapezoidal shaped longitudinal screen wires 41 with a screen gap 46 to contain classified media 32 (see FIG. 12). Circumferential rods 47 wrap around the longitudinal screen wires 41 and are supported by longitudinal rods 48 which are used to fasten the classifier screen weldment 38 to the classifier basket assembly fastener holes 34 and the basket feet fastener holes 42 located in the motor mount weldment 17 and the basket bottom weldment 35 respectively using basket fasteners 39 (see FIG. 10). In the preferred embodiment, the classifier screen weldment 38 is designed as a Vierendeel frame capable of sustaining torsional loads transferred from the classifier shaft assembly 19 (FIG. 4) to the classifier basket assembly 18 (see FIGS. 10 and 11).

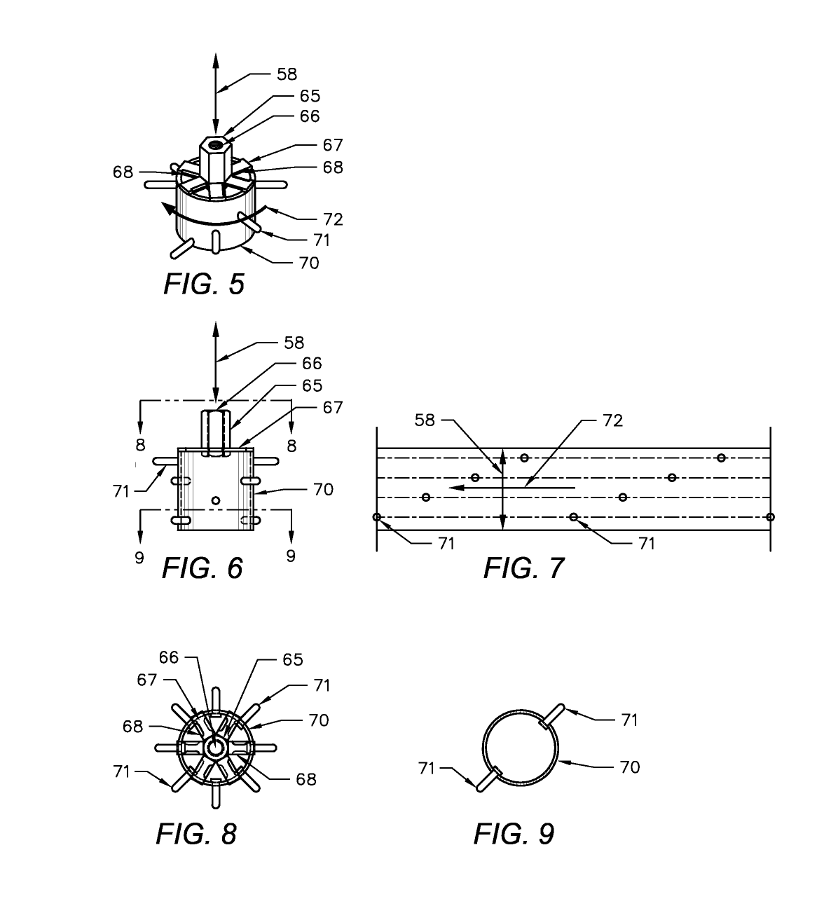

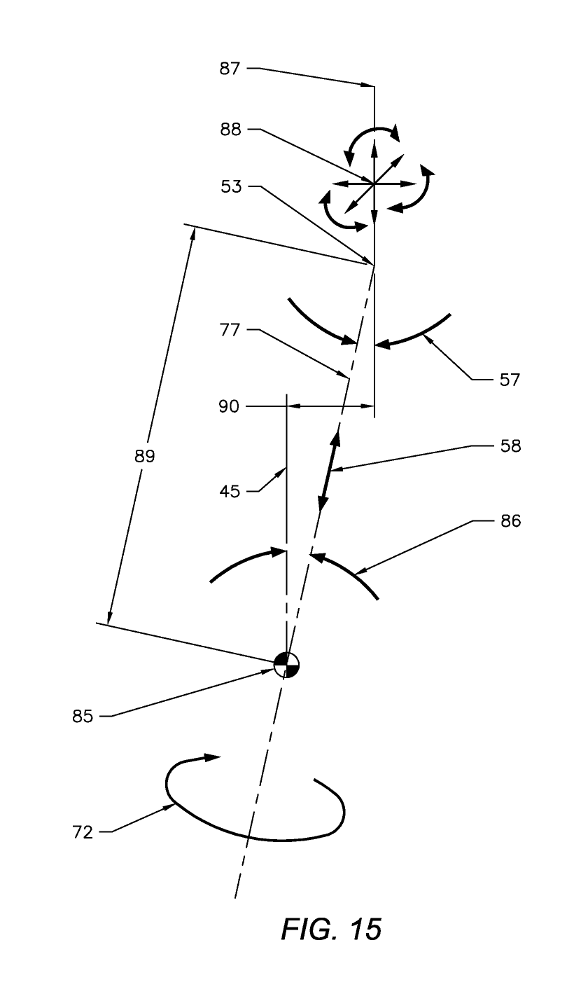

FIG. 4 illustrates the classifier shaft assembly 19 consisting of a shaft assembly 49; a classifier head weldment 50; a thrust bearing 51; a classifier blade 52 and a motor shaft coupling 53. The shaft assembly 49 consists of a shaft 54 with an integral pumping screw 55. The drive end 56 of the shaft 54 is keyed to match the motor shaft coupling 53 to allow for shaft angle fluctuations 57 and shaft axial displacements 58 (see FIGS. 1, 11, 13, 14 and 15) of the shaft 54. Also integral to the shaft 54 is a reduced shaft section 59 sized to affix a rotating radial bearing 60 secured with two bearing clamps 61, a compression spring 62 to maintain a constant compressive force on the bearing clamps 61 and rotating radial bearing 60 and a bearing nut 63, all sized to fit within the minor diameter of the pumping screw 55 thread form, a preferred embodiment of this invention. An adjustable nut 64 is used to position and secure the classifier head weldment 50 along the length of the pumping screw 55 in order for the rotating radial bearing 60 to align with the fixed radial bearing 37 (see FIGS. 10, 11, 13 and 14). The classifier head weldment 50, as further illustrated in FIGS. 5, 6, 7, 8 and 9, consists of an integral hub 65 with a threaded center 66 to match the thread form of the pumping screw 55, spokes 67 with profiled leading edges 68 for the recirculation of classified media 69 (FIG. 11) around an inverted thin walled cylinder 70 supporting a multitude of outwardly projecting classifier pins 71 in a spiral array as illustrated in FIGS. 5, 6 and 7 to resemble a screw for which to hydrostatically force the classifier head weldment 50 against the thrust bearing 51 during the rotation 72 (see also FIGS. 5, 7, 11, 13, 14 and 15) of the classifier shaft assembly 19. The pumping screw 55 extends down through the conduit 44 of the bearing post 36 (see also FIGS. 10, 11, 13 and 14). The rotating radial bearing 60 clamped to the reduced shaft section 59 fits inside the fixed radial bearing 37 (see also FIGS. 10, 11, 13 and 14). The radial clearance between the inside diameter of the fixed radial bearing 37 and the outside diameter of the rotating radial bearing 60 is the radial bearing gap 73 (FIGS. 10, 11, 13 and 14). The tip of the reduced shaft section 59 is fitted with a classifier blade 52 (FIGS. 10, 11 and 13). The profile of the classifier blade 52 can be selected based on the soil conditions and process parameters. The motor shaft coupling 53 (FIGS. 1 and 4) is rigidly fastened to the output shaft of the motor 20 (FIG. 1). The opposite end of the coupling 53 fits loosely to the drive end 56 of the classifier drive shaft 54 to allow for shaft angle fluctuations 57 and shaft axial displacements 58 (FIGS. 1 and 15).

FIG. 10 partially illustrates an assembled soil classifier 16 in a vessel 21. The pumping screw 55 is inserted through the thrust bearing 51 and the conduit 44 (see FIG. 13 for exaggerated view) in the bearing post 36 which is secured to the threaded center of the basket bottom 43. Classified media 32 is added to the inside of the classifier basket assembly 18 and in the classified media reservoir 74 within the classifier head weldment 50, to a classified media fill level 75 appropriate for the process conditions and below the fixed axial bearing 76 end of the bearing post 36 (see also FIG. 3). The shaft assembly 49 is inserted up through the basket inlet 26 of the motor mount weldment 17. FIG. 10 further illustrates the assembly of the basket gasket 31 compressed within the recessed lip 30 and the classifier screen weldment 38 and secured with the basket fasteners 39. The classifier screen weldment 38 can be inverted as the longitudinal screen wires 41 erode to extend its useful life and is an embodiment of this invention. Liquid vehicle 29 and soils 28 to be classified are added to the vessel 21 to a level above the basket lid 24.

FIG. 11 illustrates the soil classifier 16 in operation as the classifier drive assembly 19 rotates 72 about the shaft centerline 77. The rotation 72 (FIG. 5) of the classifier head weldment 50 causes the ascension of classified media 78 within the classifier screen weldment 38 while the slope of the basket bottom 25 assists in the centrifugal conveyance of classified media 79 from the classified media reservoir 74. The profiled leading edges 68 of the spokes 67 of the classifier head weldment 50 are shaped to provide a recirculation of classified media 69 through the classified media reservoir 74 to better distribute classified media 32 along the inside surface of the longitudinal screen wires 41 of the classifier screen weldment 38. The rotation 72 of the classifier blade 52 (FIG. 4) causes soils 28 to be suspended throughout the liquid vehicle 29 in a turbulent flow 80 throughout the vessel 21. Flow through the basket inlet 27 is developed by centrifugal pumping forces produced by the rotation 72 (FIG. 5) of the classifier head weldment 50 followed by the process flow 81 of classified soils 28 and liquid vehicle 29 out through the screen gaps 46 (see also FIG. 12). In addition to the work performed by the pumping screw 55, flow of soils and liquid vehicle through the bearings 82 is produced by the aforementioned centrifugal forces, however is limited by the radial bearing gap 73 (FIGS. 13 and 14). The flow through the basket inlet 27 plus the flow of soils and liquid vehicle through the bearings 82 equals the total process flow 81 out through the screen gaps 46.

FIG. 12, a partial section view taken on line 12-12 of FIG. 11, illustrates the rotation 72 of the classifier pins 71 and process flow 81 out through the screen gaps 46 of the longitudinal screen wires 41. The screen gap 46 is approximately one half of the diameter of the classified media 32 to prevent the classified media 32 from exiting the screen 41.

FIG. 13 illustrates part of the classifier shaft assembly 19 (FIG. 4), the thrust bearing 51, the bearing post 36, the fixed radial bearing 37 and the rotating radial bearing 60, all exaggerated in the radial direction to better illustrate the flow of soils and liquid vehicle through the bearings 82. During the rotation 72 of the classifier shaft assembly 19, the flow of soils and liquid vehicle through the bearings 82 pumps through the radial bearing gap 73, along the length of the conduit 44, through the axial bearing gap 83 formed between the thrust bearing 51 and the fixed axial bearing 76, and then into the classified media reservoir 74. The flow of soils and liquid vehicle through the bearings 82 develop fluid dynamic bearing films 84 within the radial bearing gap 73 and the axial bearing gap 83. The direction of the flow of soils and liquid vehicle through the bearings 82 prevent classified media 32 from exiting the classifier basket assembly 18 (FIG. 11) through the conduit 44. The fixed radial bearing 37, the rotating radial bearing 60, the conduit centerline 45 of and the shaft centerline 77 all coincide at a fulcrum point 85.

FIG. 14 further illustrates the formation of a fluid dynamic bearing film 84 during the flow of soils and liquid vehicle through the bearings 82 as limited by the radial bearing gap 73 sized to allow for bearing post angle fluctuations 86 and the shaft axial displacements 58 through the fulcrum point 85 during the rotation 72 of the classifier shaft assembly 19.

FIG. 15 illustrates the multiple degrees of freedom of the stirring system, an embodiment of this invention. During the operation of the soil classifier 16 (FIG. 11), the motor centerline 87 (see also FIGS. 1 and 2) is free to articulate about a motor platform point 88 relative to the fulcrum point 85 (see also FIG. 13) due to the flexible design of the Vierendeel frame motor mount weldment 17 (FIGS. 1 and 2). In addition to the fully articulated motor platform point 88, a motor shaft coupling 53 (FIGS. 1 and 4) allows for continuous shaft angle fluctuations 57 and shaft axial displacements 58 in order for the shaft centerline 77 of the drive shaft 54 (FIG. 4) to self-center through the fulcrum point 85 (see also FIGS. 1 and 13) within the conduit 44 (FIG. 13) of the bearing post 36 (FIG. 13) during rotation 72 of the drive assembly 19 (FIG. 4). The conduit 44 (FIG. 13) allows room for the continuous bearing post angle fluctuations 86 to the centerline 45 of the bearing post 36 and the shaft centerline 77 (FIGS. 1 and 13). Any dynamic shaft axial displacement 58 of the drive assembly 19 will correspondingly vary the pathway of the classifier pins 71 (see also FIGS. 5, 6 and 7) through the classified media 32 (FIG. 11). Since the distance 89 and the offset 90 between the motor coupling 53 and the fulcrum point 85 are allowed to vary with multiple degrees of freedom, the need for machined parts with strict dimensional tolerances is obviated, thereby significantly reducing production costs.

Consequently, this invention is optimized for an effective application of fluid dynamic bearing films consisting of process components, pumped through the gaps of radial and axial bearings with the assistance of a pumping screw within a conduit and driven by a motor mounted on a fully articulated motor platform, all with the intent of providing a low cost, portable soil classifier for the deconglomeration, dispersion, particle size reduction and classification of soils (or like materials) to the same size.

The embodiment of the invention in which an exclusive property or privilege is claimed are defined as follows:

1. A soil classifier comprising a motor mount weldment, a classifier basket assembly containing classified media, a classifier shaft assembly and a motor all of which is self-supporting within a vessel containing liquid vehicle and soils to be classified.

2. The soil classifier of claim 1, further characterized by said motor mount weldment forming a flexible Vierendeel frame, an integral basket lid with a funnel shaped concentric inlet and a basket gasket.

3. The soil classifier of claim 2, further characterized by said motor mount weldment consisting of multiple bent bars as means for the motor centerline to fully articulate about the motor platform point in relation to said integral basket lid.

4. The soil classifier of claim 2, further characterized by said integral basket lid having a recessed lip to protect and preserve said basket gasket.

5. The soil classifier of claim 1, further characterized by said motor mount weldment as means to support the weight and dynamic loads of said motor.

6. The soil classifier of claim 1, further characterized by said classifier basket assembly comprising a basket bottom weldment, a bearing post, a classifier screen weldment, a basket gasket and basket fasteners.

7. The soil classifier of claim 6, further characterized by said basket bottom weldment as self-supporting on basket feet.

8. The soil classifier of claim 6, further characterized by said basket bottom weldment having a recessed lip to protect and preserve said basket gasket.

9. The soil classifier of claim 6, further characterized by said basket bottom weldment with means to affix said bearing post to the center of the basket bottom.

10. The soil classifier of claim 6, further characterized by said bearing post comprising a coaxial fixed radial bearing, a conduit along a conduit centerline and a fixed axial bearing.

11. The soil classifier of claim 10, further characterized by a fulcrum point located at the midpoint of the centerline of said fixed radial bearing.

12. The soil classifier of claim 10, further characterized by said fixed axial bearing to be above the level of the classified media fill level.

13. The soil classifier of claim 6, further characterized by said classifier screen weldment having multiple integral longitudinal rods as means to affix basket fasteners.

14. The soil classifier of claim 6, further characterized by said basket gasket as means to provide an elastomeric compression force to prevent loosening of said basket fasteners.

15. The soil classifier of claim 1, further characterized by said classifier shaft assembly comprising a motor shaft coupling, a shaft assembly, a classifier head weldment, a thrust bearing and a classifier blade.

16. The soil classifier of claim 15, further characterized by said motor shaft coupling rigidly affixed to the motor shaft with means to articulate angularly and axially in relation to the drive end of said shaft assembly for shaft angle fluctuations and shaft axial displacements while transmitting rotational forces to said classifier shaft assembly.

17. The soil classifier of claim 15, further characterized by said shaft assembly consisting of a shaft, an adjustable nut, a rotating radial bearing, bearing clamps, a compression spring and a bearing nut.

18. The soil classifier of claim 17, further characterized by said shaft consisting of a drive end, a pumping screw and a reduced shaft section all of which are in alignment with a shaft centerline.

19. The soil classifier of claim 18, further characterized by said drive end of said shaft with means to articulate angularly and axially in relation to said motor shaft coupling for said shaft angle fluctuations and said shaft axial displacements and with means to transmit rotational forces.

20. The soil classifier of claim 17, further characterized by said rotating radial bearing to be axially clamped between said bearing clamps while said compression spring and said bearing nut maintains an axial compression force on said rotating radial bearing as means to reduce tensile stresses within said rotating radial bearing material all of which are affixed to said reduced shaft section.

21. The soil classifier of claim 15, further characterized by said classifier head weldment consisting of a hub with a radial array of spokes supporting a coaxial thin walled cylinder of which supports an outwardly projecting array of classifier pins.

22. The soil classifier of claim 21, further characterized by said spokes profiled leading edges as means to induce a flow through said thin walled cylinder during the rotation of said classifier shaft assembly.

23. The soil classifier of claim 15, further characterized by means to affix said classifier head weldment along length of said shaft assembly as means to align said rotating radial bearing coaxially within said fixed radial bearing forming a radial bearing gap in between the outside diameter of said rotating radial bearing and inside diameter of said fixed radial bearing.

24. The soil classifier of claim 1, further characterized by a classified media reservoir within said thin walled cylinder of said classifier head weldment as means to reduce starting torque loads of said motor.

25. The soil classifier of claim 1, further characterized by said profiled leading edges of said spokes of said classifier head weldment as means for the recirculation of classified media down through said classified media reservoir resulting in the ascension of classified media along the inside surface of said classifier screen weldment during said rotation of said classifier shaft assembly.

26. The soil classifier of claim 1, further characterized by said thrust bearing as means to transfer axial loads of said classifier shaft assembly to said fixed axial bearing forming an axial bearing gap in between said thrust bearing and said fixed axial bearing.

27. The soil classifier of claim 1, further characterized by means to affix a classifier blade of sorts to the tip of said reduced shaft section protruding out through the bottom of said basket bottom weldment as means to provide turbulent flow of said liquid vehicle and said soils in said vessel during said rotation of said classifier shaft assembly.

28. The soil classifier of claim 1, further characterized by said classifier basket assembly with means to affix to said motor mount weldment with said basket fasteners compressing said basket gasket within said recessed lip.

29. The soil classifier of claim 1, further characterized by said classifier basket assembly as means to support static and dynamic loads of said motor mount weldment and said motor on the floor of said vessel.

30. The soil classifier of claim 1, further characterized by said pumping screw mounted within said conduit as means to pump said liquid vehicle and said soils up through said radial bearing gap, said conduit, said axial bearing gap and into said classified media reservoir during said rotation of said classifier shaft assembly.

31. The soil classifier of claim 1, further characterized by means of said shaft centerline to self-align with said fulcrum point during said rotation of said classifier shaft assembly.

32. The soil classifier of claim 1, further characterized by said classifier shaft assembly means for said shaft axial displacements in relation to said fulcrum point.

33. The soil classifier of claim 1, further characterized by means for bearing post angle fluctuations in relation to shaft centerline about said fulcrum point.

34. The soil classifier of claim 1, further characterized by said thrust bearing means to translate laterally across the surface of the said fixed axial bearing during said bearing post angle fluctuations.

35. The soil classifier of claim 1, further characterized by means for the fluctuation of distance between said motor platform point and said fulcrum point.

36. The soil classifier of claim 1, further characterized by means to support said classifier shaft assembly with fluid dynamic bearing films consisting of the flow of liquid vehicle and soils through said radial bearing gap and said axial bearing gap.

37. The soil classifier of claim 1, further characterized by the said flow of liquid vehicle and soils through said radial bearing gap and said axial bearing gap as further means to classify soils.
